(19) United States
(12) Patent Application Publication
(10) Pub. No.: US 2025/0164765 A1
(43) Pub. Date: May 22, 2025

(54) CATADIOPTRIC LENS SYSTEM AND VIDEO SEE-THROUGH DEVICE EQUIPPED THEREWITH

(71) Applicant: SAMSUNG ELECTRONICS CO., LTD., Suwon-si (KR)

(72) Inventors: Youngmo JEONG, Suwon-si (KR); Jongchul Choi, Suwon-si (KR)

(73) Assignee: SAMSUNG ELECTRONICS CO., LTD., Suwon-si (KR)

(21) Appl. No.: 19/033,197

(22) Filed: Jan. 21, 2025

Related U.S. Application Data
(63) Continuation of application No. PCT/KR2023/009318, filed on Jul. 3, 2023.

(30) Foreign Application Priority Data
Jul. 21, 2022 (KR) 10-2022-0090577
Feb. 13, 2023 (KR) 10-2023-0018985

(51) Int. Cl. G02B 17/08

(52) U.S. Cl. CPC G02B 17/08

(57) ABSTRACT

Provided is a catadioptric lens system implemented in a video see-through apparatus, the catadioptric lens system including a first lens, a second lens, a third lens, and a fourth lens sequentially disposed in a direction of an optical axis from a side of a user's eye toward a side of an image surface, wherein a second surface of the first lens facing the image surface is configured to reflect at least a portion of light from the second lens and a fourth surface of the second lens facing the image surface is configured to re-reflect at least a portion of light reflected from the first lens, wherein the first lens has a positive refractive power, the second lens has a positive refractive power, the third lens has a negative refractive power, and the fourth lens has a positive refractive power, and wherein the first lens is configured to move.

### CROSS-REFERENCE TO RELATED APPLICATIONS

This application is a bypass continuation of International Application No. PCT/KR2023/009318, filed on Jul. 3, 2023, which is based on and claims priority to Korean Patent Application No. 10-2022-0090577, filed on Jul. 21, 2022 and Korean Patent Application No. 10-2023-0018985, filed on Feb. 13, 2023, in the Korean Intellectual Property Office, the disclosures of which are incorporated by reference herein in their entireties.

### BACKGROUND

### 1. Field

Embodiments of the present disclosure relate to a catadioptric lens system and a video see-through apparatus including the same.

### 2. Description of Related Art

Interest in video see-through (VST) apparatuses has increased. A video see-through method allows a user to enjoy virtual reality (VR) or augmented reality (AR) by wearing a head mounted display (HMD) with a camera attached thereto.

A video see-through apparatus is required to be lightweight and compact, and an optical system used in the video-see-through apparatus is required to have a wide field of view (FOV) and transmit a high-quality image. The optical system includes a lens system including one or more lens elements arranged in an optical-axis direction from the side of the user's pupil to the side of a display surface. The lens system is designed to provide the maximum performance for the maximum FOV at a fixed viewpoint, and for example, a catadioptric lens system also referred to as a pancake lens is used to implement an optical system for a thin video see-through apparatus.

### SUMMARY

One or more embodiments provide a catadioptric lens system and a video see-through apparatus including the same.

According to an aspect of one or more embodiments, there is provided a catadioptric lens system implemented in a video see-through apparatus, the catadioptric lens system including a first lens, a second lens, a third lens, and a fourth lens, wherein the first lens, the second lens, the third lens, and the fourth lens are sequentially disposed in a direction of an optical axis from a side of a user's eye toward a side of an image surface, wherein a second surface of the first lens facing the image surface is configured to reflect at least a portion of light from the second lens and a fourth surface of the second lens facing the image surface is configured to re-reflect at least a portion of light reflected from the first lens, wherein the first lens has a positive refractive power, the second lens has a positive refractive power, the third lens has a negative refractive power, and the fourth lens has a positive refractive power, wherein the first lens is configured to move in the direction of the optical axis within a distance range of 0.1 mm to 1.1 mm from the second lens, and wherein a change of refractive power within a movement range of the first lens is within a range of −7D to +1D.

The first lens may be further configured to move in the direction of the optical axis within a distance range of 0.15 mm to 1.03 mm from the second lens.

A modulation transfer function (MTF) of 0.5 field at a predetermined wavelength and a predetermined vision may be greater than or equal to 0.6 at fs/4, and the MTF of 0.5 field within the movement range of the first lens may be greater than or equal to 70% 0.6.

A modulation transfer function (MTF) of 0.7 field at a predetermined wavelength and a predetermined vision may be greater than or equal to 0.5 at fs/4, and the MTF of 0.7 field within a range in which a magnification is adjusted may be greater than or equal to 70% of 0.5.

A modulation transfer function (MTF) of 0.8 field at a predetermined wavelength and a predetermined vision may be greater than or equal to 0.4 at fs/4, and the MTF of 0.8 field within a range in which a magnification is adjusted may be greater than or equal to 70% of 0.4.

An eye relief of the catadioptric lens system may be within a range of 11 mm to 14 mm.

A field of view of the catadioptric lens system may be within a range of 85° to 95°.

The catadioptric lens system may further include a reflection polarizer between the first lens and the second lens, a quarter-wavelength plate between the reflection polarizer and the second lens, and a half mirror between the second lens and the third lens.

The reflection polarizer and the quarter-wavelength plate may be in a film form and on the second surface of the first lens.

The catadioptric lens system may further include a second quarter-wavelength plate between the fourth lens and the image surface.

The catadioptric lens system may further include a linear polarizer and a second quarter-wavelength plate on an image-surface-side of the fourth lens.

The first lens, the second lens, the third lens, and the fourth lens may include a plastic lens.

The first lens, the second lens, the third lens, and the fourth lens may include an aspherical lens.

The second surface of the first lens may include a flat surface.

According to an aspect of one or more embodiments, there is provided a video see-through apparatus including a display panel configured to output light of an image, and a catadioptric lens system including a first lens, a second lens, a third lens, and a fourth lens, wherein the first lens, the second lens, the third lens, and the fourth lens are sequentially disposed in a direction of an optical axis from a side of a user's eye toward a side of an image surface, wherein a second surface of the first lens facing the image surface is configured to reflect at least a portion of light from the second lens and a fourth surface of the second lens facing the image surface is configured to re-reflect at least a portion of light reflected from the first lens, wherein the first lens has a positive refractive power, the second lens has a positive refractive power, the third lens has a negative refractive power, and the fourth lens has a positive refractive power, wherein the first lens is configured to move in the direction of the optical axis within a distance range of 0.1 mm to 1.1 mm from the second lens, and wherein a change of refractive power within a movement range of the first lens is within a range of −7D to +1D.

The first lens may be further configured to move in the direction of the optical axis within a distance range of 0.15 mm to 1.03 mm from the second lens.

A modulation transfer function (MTF) of 0.5 field at a predetermined wavelength and a predetermined vision may be greater than or equal to 0.6 at fs/4, and the MTF of 0.5 field within the movement range of the first lens may be greater than or equal to 70% 0.6.

A modulation transfer function (MTF) of 0.7 field at a predetermined wavelength and a predetermined vision may be greater than or equal to 0.5 at fs/4, and the MTF of 0.7 field within a range in which a magnification is adjusted may be greater than or equal to 70% of 0.5.

A modulation transfer function (MTF) of 0.8 field at a predetermined wavelength and a predetermined vision may be greater than or equal to 0.4 at fs/4, and the MTF of 0.8 field within a range in which a magnification is adjusted may be greater than or equal to 70% of 0.4.

An eye relief of the catadioptric lens system may be within a range of 11 mm to 14 mm.

### BRIEF DESCRIPTION OF DRAWINGS

The above or other aspects, configurations, and/or advantages of an embodiment of the disclosure will be more apparent from the following description taken in conjunction with the accompanying drawings in which:

FIG. 1 schematically illustrates a video see-through apparatus according to one or more embodiments;

FIG. 2 schematically illustrates a case where a catadioptric lens system according to one or more embodiments has a first refractive power;

FIG. 3 schematically illustrates a case where a catadioptric lens system according to one or more embodiments has a second refractive power;

FIG. 4 is a graph illustrating a change in the distance between a first lens and a second lens while a catadioptric lens system according to one or more embodiments changes the refractive power;

FIG. 5 schematically illustrates a display panel according to one or more embodiments;

FIG. 6 schematically illustrates a display panel according to one or more embodiments;

FIG. 7 schematically illustrates a display panel according to one or more embodiments;

FIG. 8 is a modulation transfer function (MTF) chart of a catadioptric lens system for a red wavelength at a refractive power of −7D;

FIG. 9 is an MTF chart of a catadioptric lens system for a red wavelength at a refractive power of −5D;

FIG. 10 is an MTF chart of a catadioptric lens system for a red wavelength at a refractive power of −3D;

FIG. 11 is an MTF chart of a catadioptric lens system for a red wavelength at a refractive power of −1D;

FIG. 12 is an MTF chart of a catadioptric lens system for a red wavelength at a refractive power of +1D;

FIG. 13 is an MTF chart of a catadioptric lens system for a green wavelength at a refractive power of −7D;

FIG. 14 is an MTF chart of a catadioptric lens system for a green wavelength at a refractive power of −5D;

FIG. 15 is an MTF chart of a catadioptric lens system for a green wavelength at a refractive power of −3D;

FIG. 16 is an MTF chart of a catadioptric lens system for a green wavelength at a refractive power of −1D;

FIG. 17 is an MTF chart of a catadioptric lens system for a green wavelength at a refractive power of +1D;

FIG. 18 is an MTF chart of a catadioptric lens system for a blue wavelength at a refractive power of −7D;

FIG. 19 is an MTF chart of a catadioptric lens system for a blue wavelength at a refractive power of −5D;

FIG. 20 is an MTF chart of a catadioptric lens system for a blue wavelength at a refractive power of −3D;

FIG. 21 is an MTF chart of a catadioptric lens system for a blue wavelength at a refractive power of −1D;

FIG. 22 is an MTF chart of a catadioptric lens system for a blue wavelength at a refractive power of +1D;

FIG. 23 is an aberration diagram illustrating the longitudinal spherical aberration, astigmatic field curves, and distortion of a catadioptric lens system at a refractive power of −7D;

FIG. 24 is an aberration diagram illustrating the longitudinal spherical aberration, astigmatic field curves, and distortion of a catadioptric lens system at a refractive power of −5D;

FIG. 25 is an aberration diagram illustrating the longitudinal spherical aberration, astigmatic field curves, and distortion of a catadioptric lens system at a refractive power of −3D;

FIG. 26 is an aberration diagram illustrating the longitudinal spherical aberration, astigmatic field curves, and distortion of a catadioptric lens system at a refractive power of −1D; and

FIG. 27 is an aberration diagram illustrating the longitudinal spherical aberration, astigmatic field curves, and distortion of a catadioptric lens system at a refractive power of +1D.

### DETAILED DESCRIPTION

Hereinafter, embodiments of the present disclosure will be described in detail with reference to the accompanying drawings so that those of ordinary skill in the art may more easily implement the embodiments of the present disclosure. However, the present disclosure may be embodied in many different forms and should not be construed as being limited to the embodiments set forth herein. Also, portions irrelevant to the description of the present disclosure will be omitted in the drawings for a clear description of the present disclosure, and like reference numerals will denote like elements throughout the specification.

The terms used herein are those general terms currently widely used in the art in consideration of functions in the present disclosure, but the terms may vary according to the intentions of those of ordinary skill in the art, precedents, or new technology in the art. Also, in some cases, there may be terms that are optionally selected by the applicant, and the meanings thereof will be described in detail in the corresponding portions of the present disclosure. Thus, the terms used herein should be understood not as simple names but based on the meanings of the terms and the overall description of the present disclosure.

As used herein, the singular forms “a”, “an”, and “the” are intended to include the plural forms as well, unless the context clearly indicates otherwise. Also, when a part “includes” or “comprises” a component, unless there is a particular description contrary thereto, the part may further include other components, not excluding the other components.

It will be understood that, although the terms first, second, third, fourth, etc. may be used herein to describe various elements, components, regions, layers and/or sections (collectively “elements”), these elements should not be limited by these terms. These terms are only used to distinguish one element from another element. Thus, a first element described in this description section may be termed a second element or vice versa in the claim section without departing from the teachings of the disclosure.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

As used herein, an expression “at least one of” preceding a list of elements modifies the entire list of the elements and does not modify the individual elements of the list. For example, an expression, “at least one of a, b, and c” should be understood as including only a, only b, only c, both a and b, both a and c, both b and c, or all of a, b, and c.

Hereinafter, the present disclosure will be described in detail with reference to the accompanying drawings.

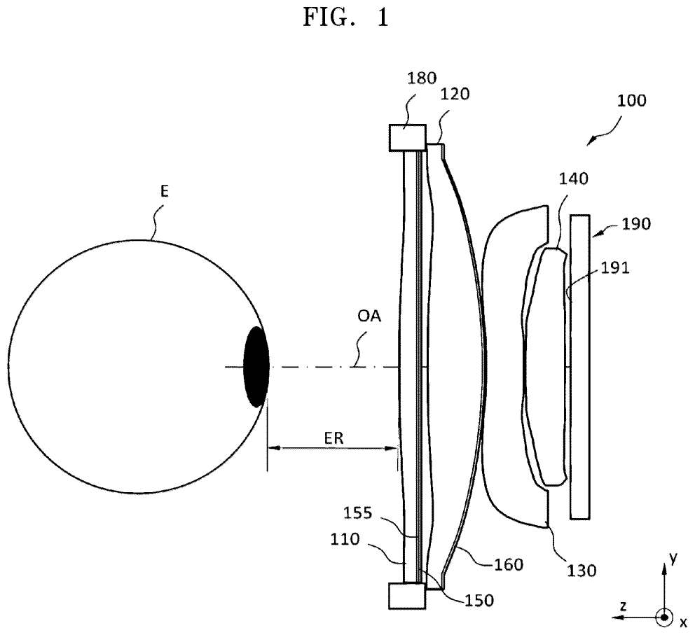

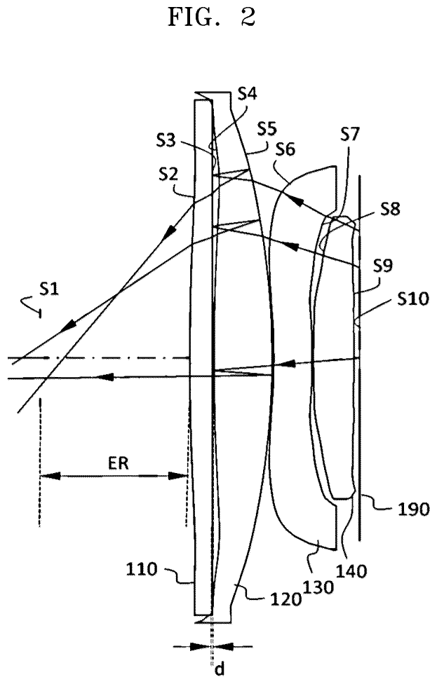

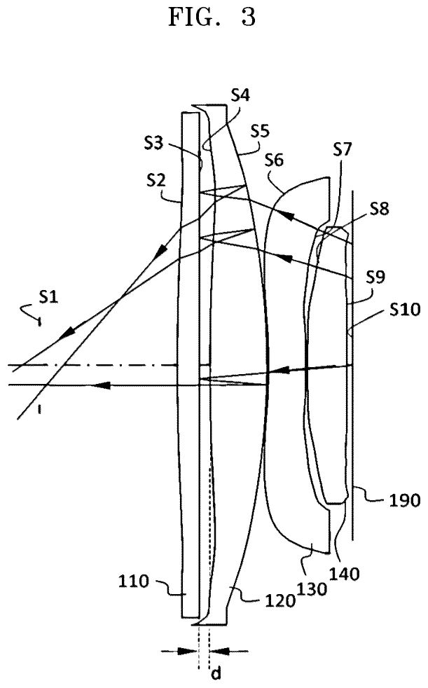

FIG. 1 schematically illustrates a video see-through apparatus according to one or more embodiments, FIG. 2 schematically illustrates a case where a catadioptric lens system 100 according to one or more embodiments has a first refractive power, and FIG. 3 schematically illustrates a case where a catadioptric lens system 100 according to one or more embodiments has a second refractive power.

Referring to FIG. 1, an electronic apparatus may include a catadioptric lens system 100 and a display panel 190. The electronic apparatus may be, for example, a video see-through apparatus configured to enable the user to see an image displayed on the display panel 190 while wearing the electronic apparatus, such as a head mounted display (HMD). The catadioptric lens system 100 may direct an image generated by the display panel 190 to the user's pupil, and when the user wears the electronic apparatus, the catadioptric lens system 100 may be located adjacent to the user's pupil. Based on the catadioptric lens system 100 being located adjacent to the user's pupil, the electronic apparatus may be understood as a near-eye display apparatus. Also, based on the user being able to wear the electronic apparatus on the user's head, the electronic apparatus may be understood as a wearable device. The electronic apparatus may be configured to include a separate camera to photograph and capture a real scene and provide the real scene to the user through the display panel 190. The electronic apparatus may be a virtual reality (VR) device providing virtual reality (VR) or an augmented reality (AR) device providing augmented reality (AR). Although the catadioptric lens system 100 and the display panel 190 for one eyeball E are illustrated, the catadioptric lens system 100 and the display panel 190 may be arranged for each of the user's left and right eyes.

The catadioptric lens system 100 may include a first lens 110, a second lens 120, a third lens 130, and a fourth lens 140. The first to fourth lenses 110, 120, 130, and 140 may be sequentially arranged from the side of an object (i.e., the user's eye) to the side of an image surface 191 of the display panel 190. The user's eye E may be intended for the front end of the first lens 110.

The first lens 110 may have a positive (+) refractive power, the second lens 120 may have a positive (+) refractive power, the third lens 130 may have a negative (−) refractive power and the fourth lenses 110 lens 140 may have a positive (+) refractive power.

The first to fourth lenses 110, 120, 130, and 140 may include a plastic material. Each of the first to fourth lenses 110, 120, 130, and 140 may be an aspherical lens with at least one aspherical surface.

A first surface S2 of the first lens 110 facing the user's eye E may be an aspherical surface having an apex convex toward the object side and at least one inflection point. A second surface S3 of the first lens 110, opposite to the first surface S2, facing the display panel 190 may be a flat surface.

A circular polarization plate 150 and a reflection polarizer 155 may be arranged on the second surface S3 of the first lens 110. The reflection polarizer 155 may be attached in a film form to the second surface S3 of the first lens 110, and the circular polarization plate 150 may be attached in a film form to the reflection polarizer 155. For convenience, the circular polarization plate 150 and the reflection polarizer 155 are not illustrated in FIGS. 2 and 3.

The reflection polarizer 155 may be, for example, a wire grid polarizer. However, embodiments are not limited thereto. The reflection polarizer 155 may be configured to reflect light of first linear polarization and transmit light of second linear polarization orthogonal to the first linear polarization. For example, when the direction of an optical axis OA is the z-axis direction, the first linear polarization may be that light is polarized along the x-axis and the second linear polarization may be that light is polarized along the y-axis; however, embodiments are not limited thereto.

The circular polarization plate 150 may be an element that converts linearly polarized light into left-circularly polarized light or right-circularly polarized light. For example, the circular polarization plate 150 may be an optical element that polarizes and converts first linearly polarized light into first circularly polarized light (e.g., left-circularly polarized light) and polarizes and converts second linearly polarized light into second circularly polarized light (e.g., right-circularly polarized light) orthogonal to the first circularly polarized light.

A third surface S4 of the second lens 120 may be an aspherical surface that is convex at the apex toward the object side and has at least one inflection point. A fourth surface S5 of the second lens 120, opposite to the third surface S4, may be an aspherical surface that is convex toward the image surface 191 side.

A half mirror 160 may be attached in a film form to the fourth surface S5 of the second lens 120. The half mirror 160 may be an optical element that transmits a portion of incident light (e.g., 50% of the light) and reflects another portion of the incident light (e.g., 50% of the light). For convenience, the half mirror 160 is not illustrated in FIGS. 2 and 3.

A fifth surface S6 of the third lens 130 may be an aspherical surface that is concave at the apex toward the object side and has at least one inflection point. A sixth surface S7 of the third lens 130, opposite to the fifth surface S6, may be an aspherical surface that is convex at the apex toward the image surface 191 side and has at least one inflection point.

A seventh surface S8 of the fourth lens 140 may be an aspherical surface that is convex at the apex toward the object side. An eighth surface S9 of the fourth lens 140, opposite to the seventh surface S8, may be an aspherical surface that is convex at the apex toward the image surface 191 side.

As illustrated in FIGS. 2 and 3, the first lens 110 may be installed to be movable in the optical-axis direction. For example, a movable holder 180 supporting the first lens 110 may be controlled by a control signal of a controller configured to move the first lens 110 in the direction of the optical axis OA. However, embodiments are not limited thereto. As another example, the movable holder 180 may be manually operated to move the first lens 110 in the direction of the optical axis OA. The movement of the first lens 110 in the direction of the optical axis OA may be performed such that a distance d between the first lens 110 and the second lens 120 is within a range of 0.1 mm to 1.1 mm, for example, 0.15 mm to 1.03 mm.

The catadioptric lens system 100 may be configured to have a first refractive power when the distance d between the first lens 110 and the second lens 120 is a first distance, and have a second refractive power when the distance d between the first lens 110 and the second lens 120 is a second distance, and to have a value between the first refractive power and the second refractive power when the distance d between the first lens 110 and the second lens 120 is between the first distance and the second distance.

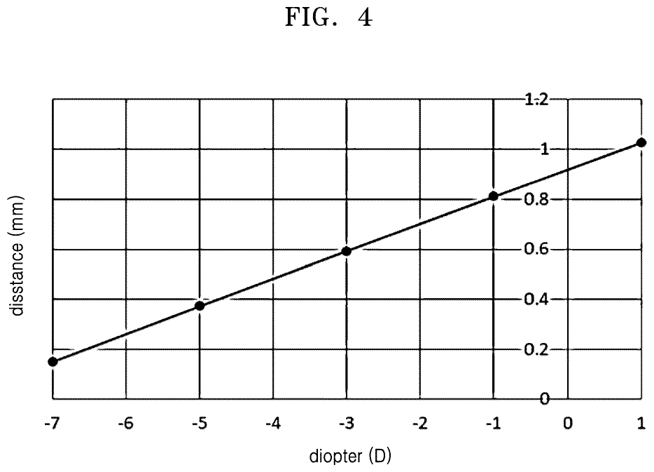

FIG. 4 is a graph illustrating a change in the distance d between the first lens 110 and the second lens 120 while the catadioptric lens system 100 according to one or more embodiments changes the refractive power. In FIG. 4, the horizontal axis represents the refractive power (in units of diopter (D)) of the catadioptric lens system 100, and the vertical axis represents the distance d (in units of mm) between the first lens 110 and the second lens 120. Referring to FIG. 4, in an embodiment, when the distance d is 0.15 mm, the first refractive power may be −7D, when the distance d is 1.03 mm, the second refractive power may be +1D, and when the distance d is between 0.15 mm and 1.03 mm, the refractive power of the catadioptric lens system 100 may be within a range of −7D to +1D.

As described above, the position of the first lens 110 in the direction of the optical axis OA may be adjusted to adjust the magnification of the catadioptric lens system 100, and accordingly, the user's vision may be corrected such that even a person with low vision may use the video see-through apparatus without using a separate optical clip.

An eye relief ER may change according to the movement of the first lens 110 in the direction of the optical axis OA. For example, because the ER changes according to the movement of the first lens 110 in the direction of the optical axis OA, the ER may change according to the refractive power of the catadioptric lens system 100. Here, the ER may refer to the distance between the user's eye and the eyepiece (i.e., the first lens 110).

According to one or more embodiments, the catadioptric lens system 100 may have the ER within a range of 11 mm to 14 mm even when the position of the first lens 110 is adjusted to correct the user's vision.

According to one or more embodiments, the ER may be within a range of 12 mm to 13 mm.

As another example, the ER may be within a range of 12.12 mm to 13.0 mm.

According to one or more embodiments, when the refractive power of the catadioptric lens system 100 is −7D, the ER may be 13.0 mm, and when the refractive power of the catadioptric lens system 100 is +1D, the ER may be 12.12 mm. In the case of vision correction using an optical clip of related art, the ER has to be increased because a space for accommodating the optical clip has to be secured. However, because the catadioptric lens system 100 of one or more embodiments corrects the vision by adjusting the position of the first lens 110, it may be unnecessary to increase the ER. Also, the catadioptric lens system 100 of one or more embodiments may minimize an ER change while providing a vision correction of −7D to +1D.

The catadioptric lens system 100 of one or more embodiments may be configured to satisfy the following modulation transfer function (MTF) at a predetermined wavelength and a predetermined vision in order to maintain uniform performance even when the magnification is adjusted. Here, the predetermined wavelength may be at least one of a red wavelength (656.0 nm), a green wavelength (587.0 nm), and a blue wavelength (486.0 nm). The predetermined vision may be at least one of refractive powers of −7D, −5D, −3D, −1D, and +1D.

In one or more embodiments, the catadioptric lens system 100 may be configured such that an MTF of 0.5 field at the predetermined wavelength and the predetermined vision is 0.6 or more at fs/4 and the MTF of 0.5 field within the range in which the magnification is adjusted is 70% or more of 0.6. Here, “fs” may denote the Nyquist frequency that is the limit frequency of theoretical resolution.

In one or more embodiments, the catadioptric lens system 100 may be configured such that an MTF of 0.7 field at the predetermined wavelength and the predetermined vision is 0.5 or more at fs/4 and the MTF of 0.7 field within the range in which the magnification is adjusted is 70% or more of 0.5.

In one or more embodiments, the catadioptric lens system 100 may be configured such that an MTF of 0.8 field at the predetermined wavelength and the predetermined vision is 0.4 or more at fs/4 and the MTF of 0.8 field within the range in which the magnification is adjusted is 70% or more of 0.4.

In one or more embodiments, the catadioptric lens system 100 may be configured to satisfy OT<2*ER. Here, “f” may denote the focal length of the catadioptric lens system 100, and “OT (Overall Thickness)” may be the total thickness of the catadioptric lens system 100 and may denote the distance from the apex of the first surface S2 of the first lens 110 to the apex of the eighth surface S9 of the fourth lens 140.

In one or more embodiments, the catadioptric lens system 100 may be configured to provide a field of view (FOV) of 70° to 100° (deg) or more.

In As another example, the catadioptric lens system 100 may be configured to provide an FOV of 85° to 95°.

In As yet another example, the catadioptric lens system 100 may be configured to provide an FOV of 89° to 90.3°.

In one or more embodiments, in order to use the maximum resolution, the catadioptric lens system 100 may be configured to provide an FOV of 90° at a refractive power of −1D, which is expected to be highly usable, to provide an FOV of 90.3° at a refractive power of +1D, and to provide an FOV of 89° at a refractive power of −7D. In this case, even when the refractive power is changed for vision correction, an FOV change and a resolution change may be minimized.

In one or more embodiments, the catadioptric lens system 100 may be configured to satisfy f<2*ER. Here, “f” may denote the focal length of the catadioptric lens system 100.

The display panel 190 may be a flat panel that displays an image by light of the first circular polarization (e.g., left-circularly polarized light or right-circularly polarized light).

Next, a light path in the catadioptric lens system 100 will be described.

The light of an image displayed on the display panel 190 may sequentially pass through the fourth lens 140 and the third lens 130 and then reach the fourth surface S5 of the second lens 120. At the half mirror 160 located on the fourth surface S5 of the second lens 120, a portion of the light may be reflected and a portion of the light may be transmitted. The light transmitted through the half mirror 160 may reach the second surface S3 of the first lens 110 by passing through the second lens 120 while maintaining the first circular polarization. The light of the first circular polarization may be converted into light of the first linear polarization by the quarter-wavelength plate 150 located on the second surface S3 of the first lens 110 and may be reflected by the reflection polarizer 155. Because the reflection polarizer 155 does not change the polarization direction of the linear polarization, the light reflected by the reflection polarizer 155 may maintain the first linear polarization. The light of the first linear polarization may be converted back into the first circular polarization while passing through the quarter-wavelength plate 150 again. The light converted back into the first circular polarization may be partially re-reflected by the half mirror 160 by passing through the second lens 120. The reflection by the half mirror 160 may change the light of the first circular polarization into light of the second circular polarization orthogonal to the first circular polarization. The light of the second circular polarization re-reflected by the half mirror 160 may be converted into light of the second linear polarization orthogonal to the first linear polarization by the quarter-wavelength plate 150 by passing through the second lens 120 again. The light of the second linear polarization may be directed to the user's eye E by passing through the reflection polarizer 155.

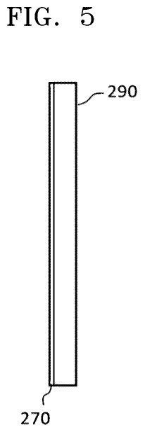

FIG. 5 schematically illustrates a display panel 290 according to one or more embodiments. Referring to FIG. 5, in one or more embodiments, the display panel 290 may be a liquid crystal display (LCD) panel. A second quarter-wavelength plate 270 may be attached in a film form to the front surface of the display panel 290. Because the LCD panel itself displays an image by linearly polarized light, linearly polarized light emitted from the display panel 290 may be converted into circularly polarized light by the second quarter-wavelength plate 270.

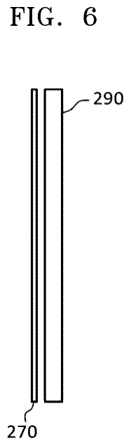

FIG. 6 schematically illustrates a display panel 290 according to one or more embodiments. As illustrated in FIG. 6, a second quarter-wavelength plate 270 may be attached to a flat substrate and arranged separately from the display panel 290. The second quarter-wavelength plate 270 may be arranged in contact with or spaced apart from the front surface of the display panel 290.

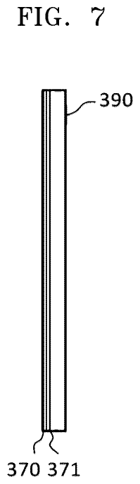

FIG. 7 schematically illustrates a display panel 390 according to one or more embodiments. Referring to FIG. 7, in one or more embodiments, the display panel 390 may be an organic light emitting diode (OLED) panel or a micro LED (μLED) panel. Because the OLED panel or the μLED panel may display an image by unpolarized light, a linear polarizer 371 and a second quarter-wavelength plate 370 may be attached in a film form to the front surface of the display panel 390. The linear polarizer 371 and the second quarter-wavelength plate 370 may be arranged to be spaced apart from the front surface of the display panel 390 in the form of being attached to a flat substrate. The light emitted from the display panel 390 may be converted into linearly polarized light by the linear polarizer 371 and then converted into circularly polarized light by the second quarter-wavelength plate 370.

Next, the catadioptric lens system 100 will be described with reference to a numerical example.

In the numerical example, “Y” may denote the radius of curvature, and “T” may denote the thickness of a lens or the gap between lenses.

Moreover, the definition of an aspherical surface used in the catadioptric lens system 100 according to one or more embodiments may be represented as follows.

When the z-axis direction is set as the optical-axis direction, the aspherical shape may be represented by the following equation by using a Forbes Q-con polynomial in a cylindrical polar coordinate system with respect to the optical-axis direction.

$$z ( ρ ) = {a}_{0} + \frac{δ {ρ}^{2}}{1 + \sqrt{1 - ( 1 + k ) {δ}^{2} {ρ}^{2}}} + {( \frac{ρ}{{ρ}_{m ax}} )}^{4} + {\sum }_{i = 0}^{13} {g}_{2 i + 4} {{Q}_{i}^{con} ( \frac{ρ}{{ρ}_{m ax}} )}^{2} \qquad < Aspherical Equation >$$

Here, “a₀” is an apex position along the optical axis (measured from the display surface), “k” is a conic constant, δ=1/Y, “Y” is the radius of curvature on an apex, and “g_{2 i+4}” is a coefficient of a Forbes Q-con polynomial Qᵢ^{con} (Forbes, Shape specification for axially symmetric optical surfaces).

The FOV of the catadioptric lens system 100 may be 90°, and the length of an image surface S10 may be 9.25 mm.

In Table 1 and Table 2, symbols S2, S3, . . . , S9 may represent the lens surfaces illustrated in FIGS. 2 and 3. “S1” may denote a stop and may correspond to the user's pupil. “S10” may denote the image surface of the display panel 190.

In Table 1 and Table 2, numerical data of the column belonging to symbols S1, S2, S3, S4, S5, S6, . . . , S9 may be for light propagating from the image surface side to the object side, and numerical data of the column belonging to symbols S4-2 and S5-2 may be for light reflected and returned from the lens surface. Numerical data of the column belonging to S4-3 may be for light reflected twice and may be seen to be substantially the same as the numerical data of the S4 column. “Y” may denote the radius of curvature, “T” may denote the thickness of a lens or the air gap between lenses, and all of the lengths may be in units of mm.

TABLE 1

| | | | | | Refrac- |
|---|---|---|---|---|---|
| | | | | | tion |
| Surface | Surface type | Y | T | Material | mode |
| Object | Sphere | Infinity | −142.8571 | | Refract |
| S1 | Sphere | Infinity | 13.0000 | | Refract |
| S2 | Qcon Asphere | 194.7172 | 1.9604 | ‘EP900025’ | Refract |
| S3 | Sphere | Infinity | 0.1500 | | Refract |
| S4 | Qcon Asphere | 133.0892 | 5.0432 | ‘APEL5014’ | Refract |
| S5 | Qcon Asphere | −48.9477 | −5.0432 | ‘APEL5014’ | Reflect |
| S4-2 | Qcon Asphere | 133.0892 | −0.1500 | | Refract |
| S3-2 | Sphere | Infinity | 0.1500 | | Reflect |
| S4-3 | Qcon Asphere | 133.0892 | 5.0432 | ‘APEL5014’ | Refract |
| S5-2 | Qcon Asphere | −48.9477 | 0.1500 | | Refract |
| S6 | Qcon Asphere | −56.1009 | 3.2731 | ‘APEL5014’ | Refract |
| S7 | Qcon Asphere | 24.6043 | 0.1500 | | Refract |
| S8 | Qcon Asphere | 25.3506 | 3.5273 | ‘EP900025’ | Refract |
| S9 | Qcon Asphere | −263.7871 | 0.5389 | | Refract |
| S10 | Sphere | Infinity | −0.0297 | | |

TABLE 2

| Parameter | S2 | S4 | S5 | S6 | S7 | S8 | S9 |
|---|---|---|---|---|---|---|---|
| Y radius | 194.7172 | 133.0892 | −48.9477 | −56.1009 | 24.6043 | 25.3506 | −263.7871 |
| Normal radius | 15.7464 | 17.2303 | 18.3653 | 14.9473 | 13.9669 | 12.6920 | 9.9401 |
| 4th-order Qcon | −0.1034 | −1.0204 | 0.0549 | 7.7669 | 17.9614 | −1.3531 | 0.1618 |
| coefficient | | | | | | | |
| 6th-order Qcon | −0.1124 | −0.2239 | −0.1256 | 3.0902 | 8.7554 | 0.1153 | 0.1147 |
| coefficient | | | | | | | |
| 8th-order Qcon | 0.0109 | 0.0369 | 0.0214 | 1.5614 | −5.2765 | 0.1577 | 0.0695 |
| coefficient | | | | | | | |
| 10th-order Qcon | −0.0117 | 0.0712 | 0.0381 | 0.8672 | −8.6356 | 1.0137 | 0.0213 |
| coefficient | | | | | | | |
| 12th-order Qcon | 0.0014 | 0.0074 | 0.0050 | 0.1982 | −6.7673 | 1.4357 | 0.0128 |
| coefficient | | | | | | | |
| 14th-order Qcon | 0.0017 | −0.0118 | −0.0052 | 0.1145 | −1.9015 | 1.7700 | −0.0535 |
| coefficient | | | | | | | |
| 16th-order Qcon | 0.0021 | −0.0115 | −0.0054 | −0.0291 | 0.1683 | 1.2264 | −0.0292 |
| coefficient | | | | | | | |
| 18th-order Qcon | −0.0013 | 0.0104 | 0.0038 | −0.0053 | 0.6796 | 0.7896 | 0.0442 |
| coefficient | | | | | | | |
| 20th-order Qcon | 0.0001 | −0.0024 | −0.0011 | −0.0484 | 0.0089 | 0.1952 | −0.0180 |
| coefficient | | | | | | | |

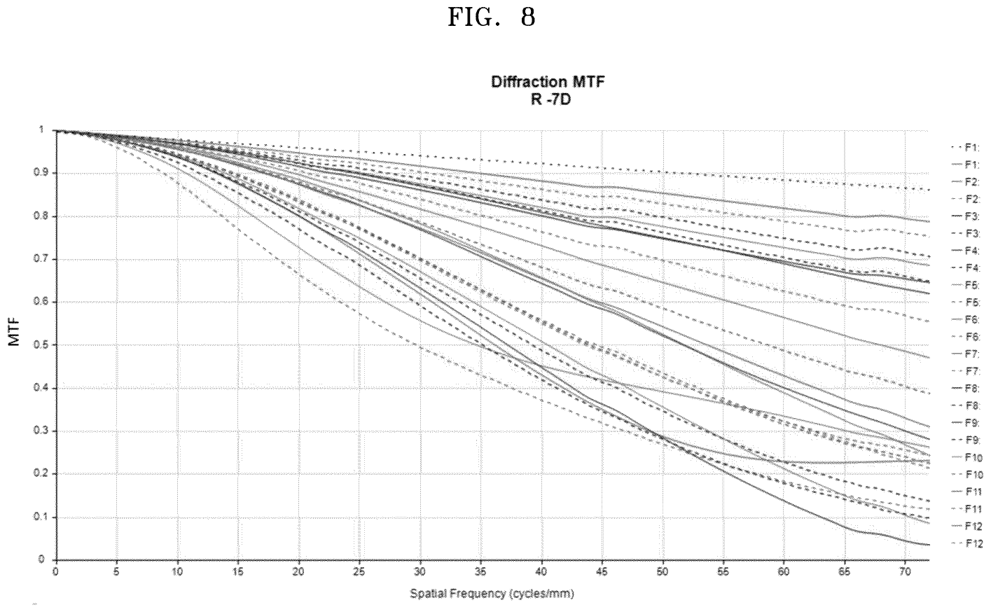

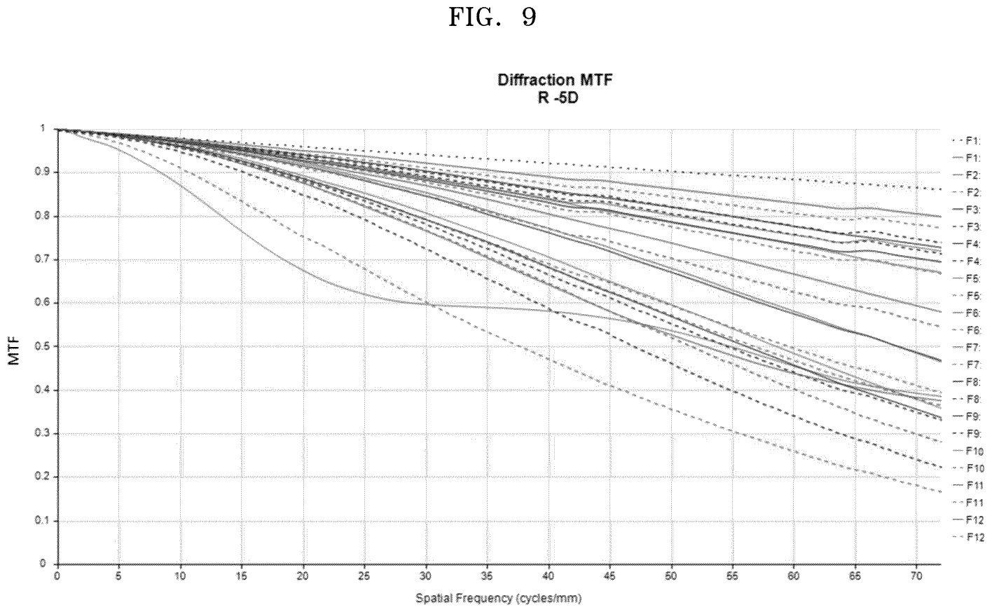

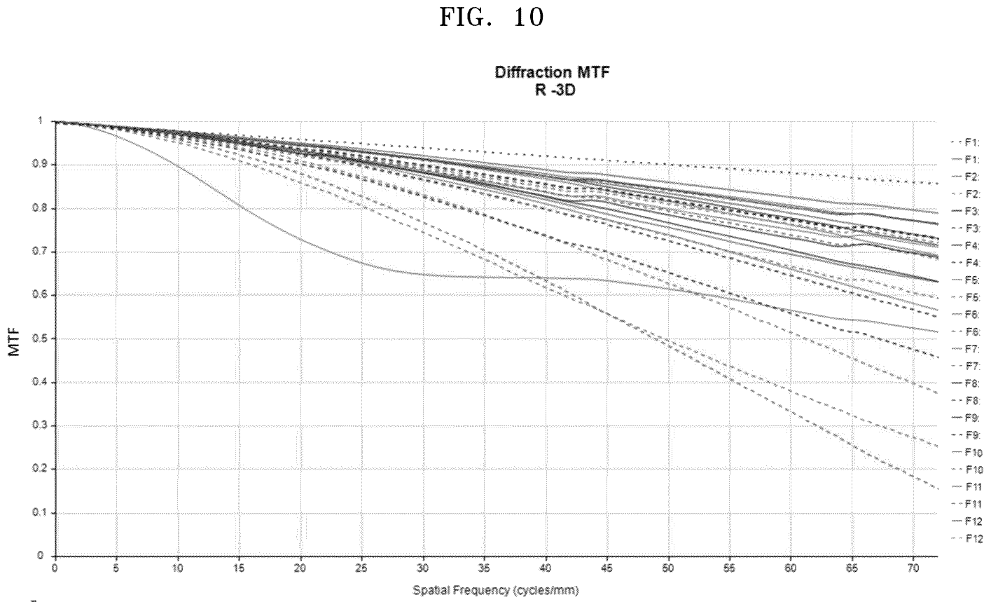

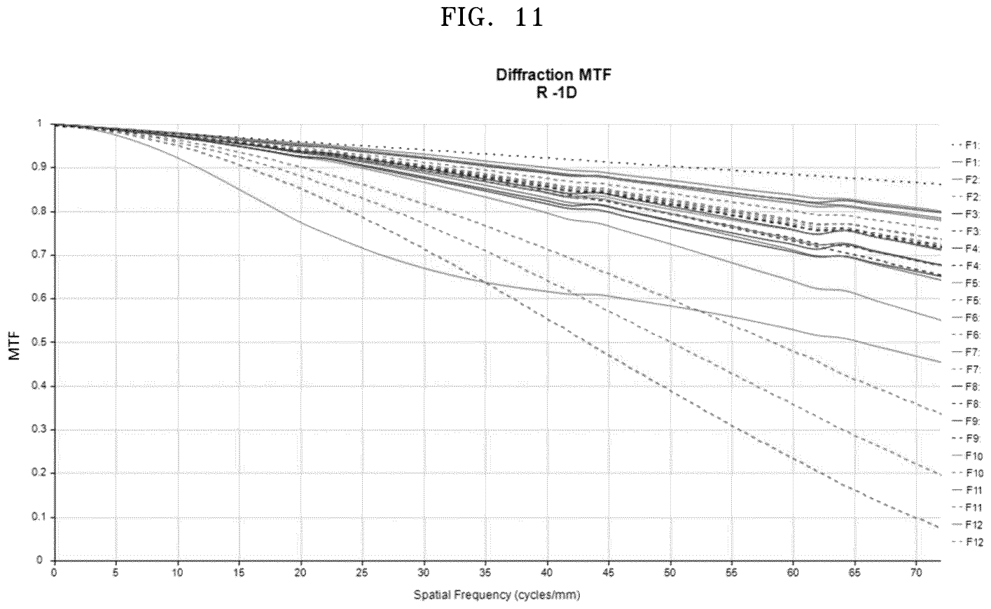

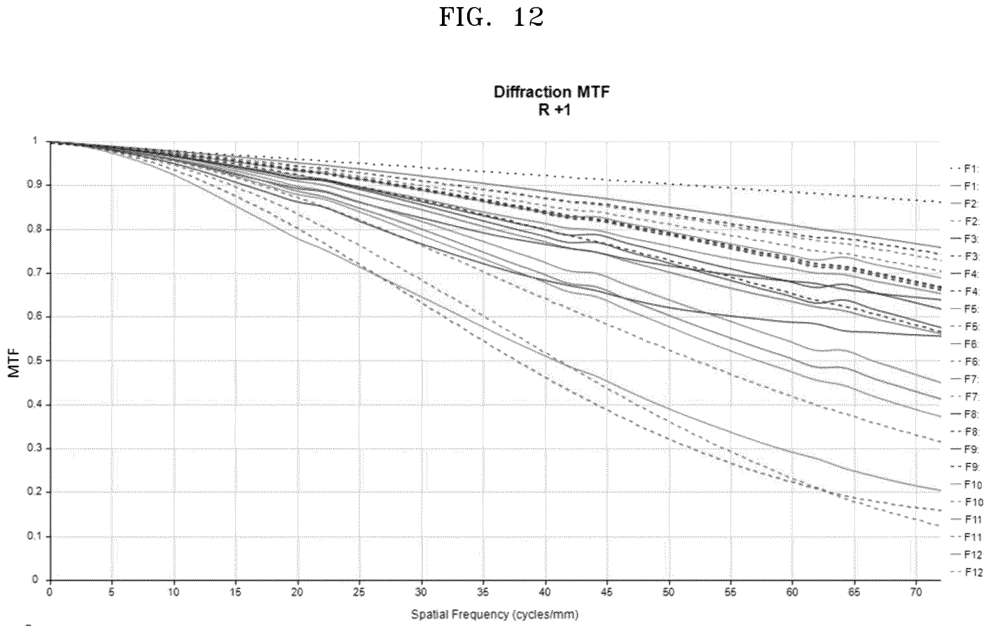

Next, with reference to the MTF chart, the performance of the catadioptric lens system 100 according to the numerical example described above will be described. FIG. 8 is an MTF chart of the catadioptric lens system 100 for a red wavelength (656.0 nm) at −7D, FIG. 9 is an MTF chart of the catadioptric lens system 100 for a red wavelength at −5D, FIG. 10 is an MTF chart of the catadioptric lens system 100 for a red wavelength at −3D, FIG. 11 is an MTF chart of the catadioptric lens system 100 for a red wavelength at −1D, and FIG. 12 is an MTF chart of the catadioptric lens system 100 for a red wavelength at +1D.

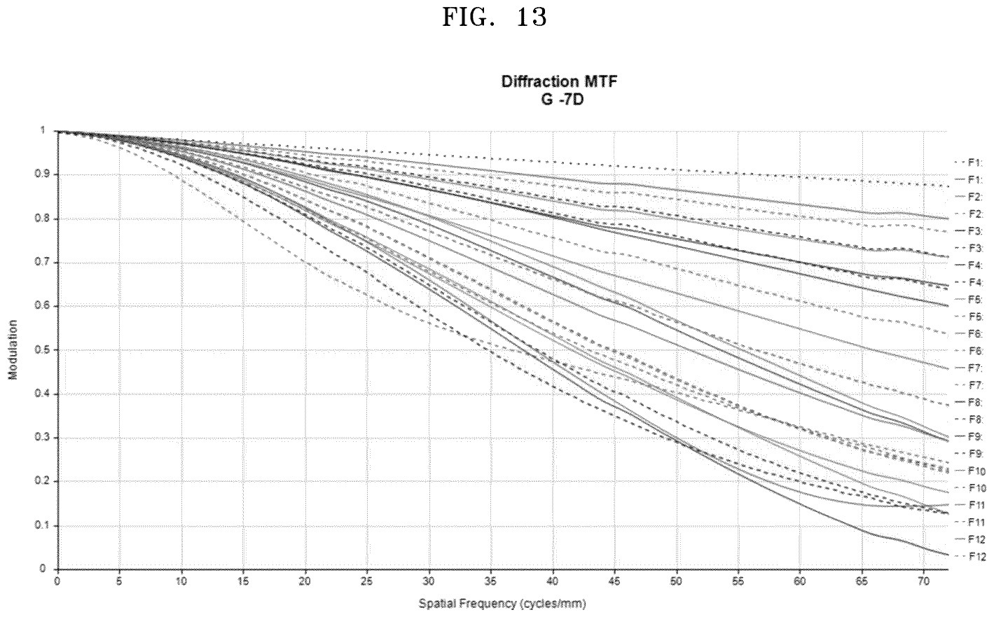

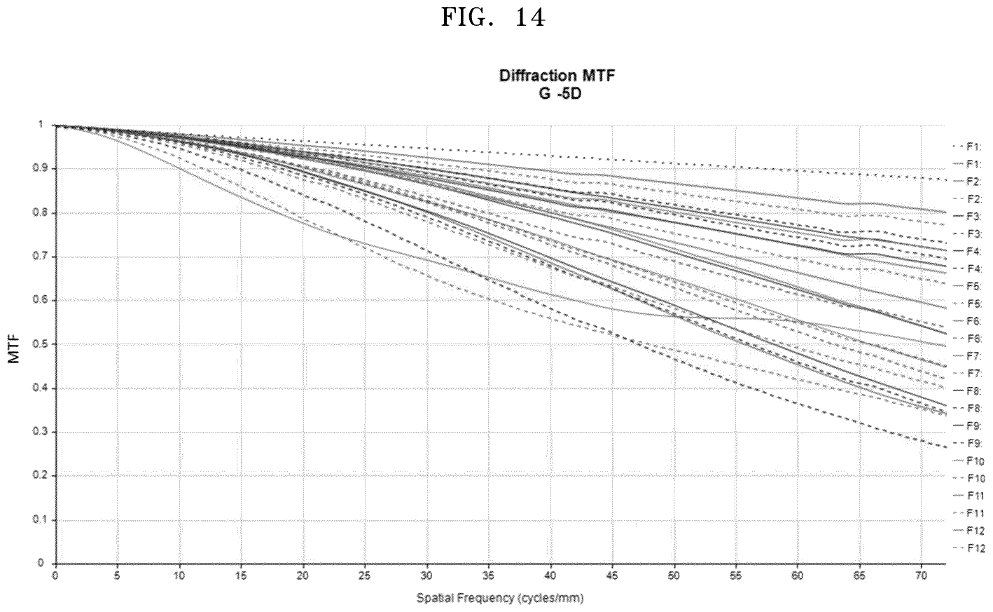

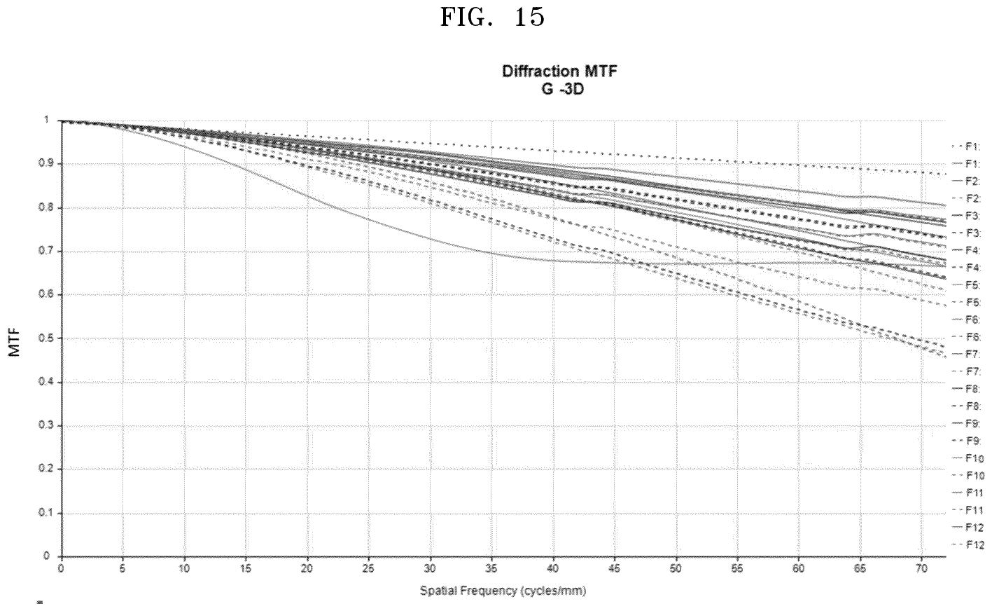

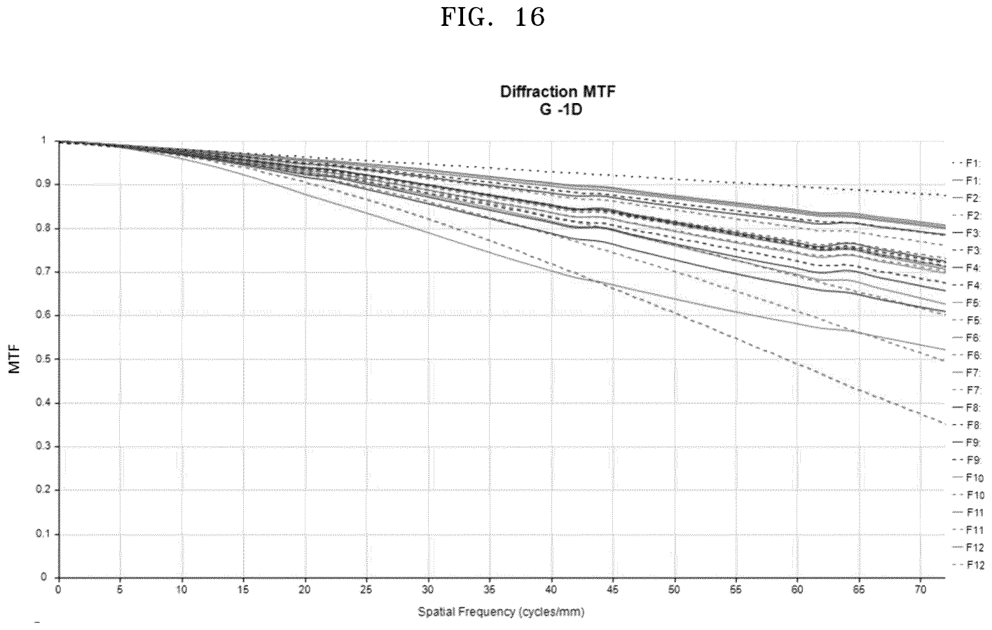

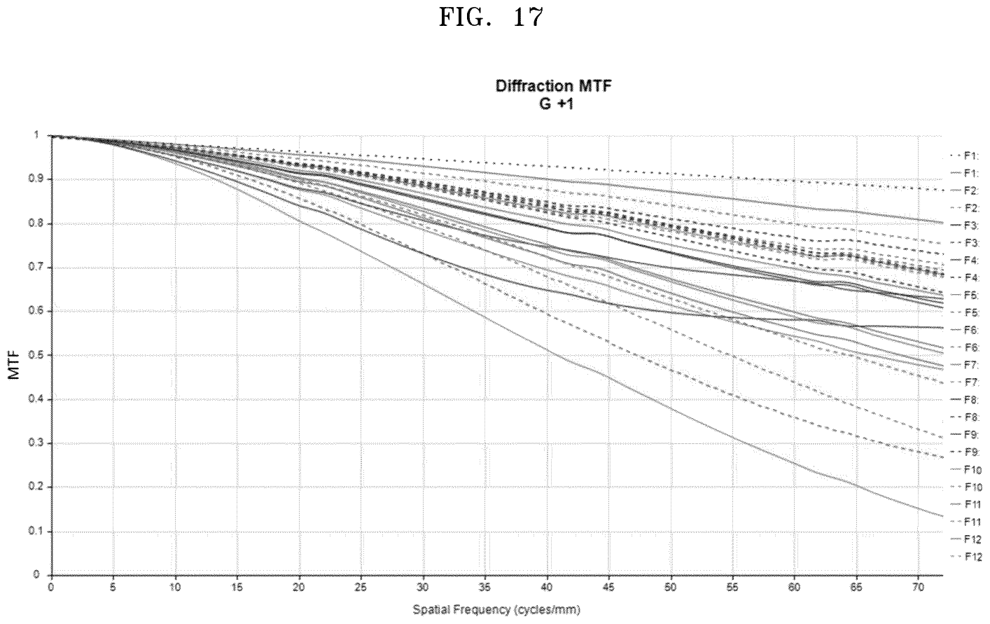

FIG. 13 is an MTF chart of the catadioptric lens system 100 for a green wavelength (587.0 nm) at −7D, FIG. 14 is an MTF chart of the catadioptric lens system 100 for a green wavelength at −5D, FIG. 15 is an MTF chart of the catadioptric lens system 100 for a green wavelength at −3D, FIG. 16 is an MTF chart of the catadioptric lens system 100 for a green wavelength at −1D, and FIG. 17 is an MTF chart of the catadioptric lens system 100 for a green wavelength at +1D.

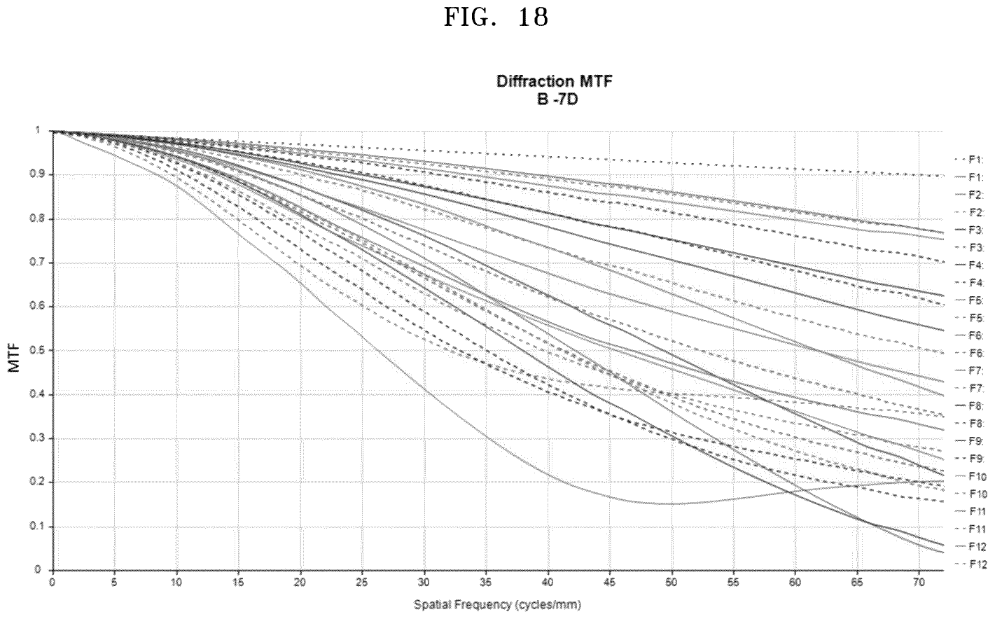

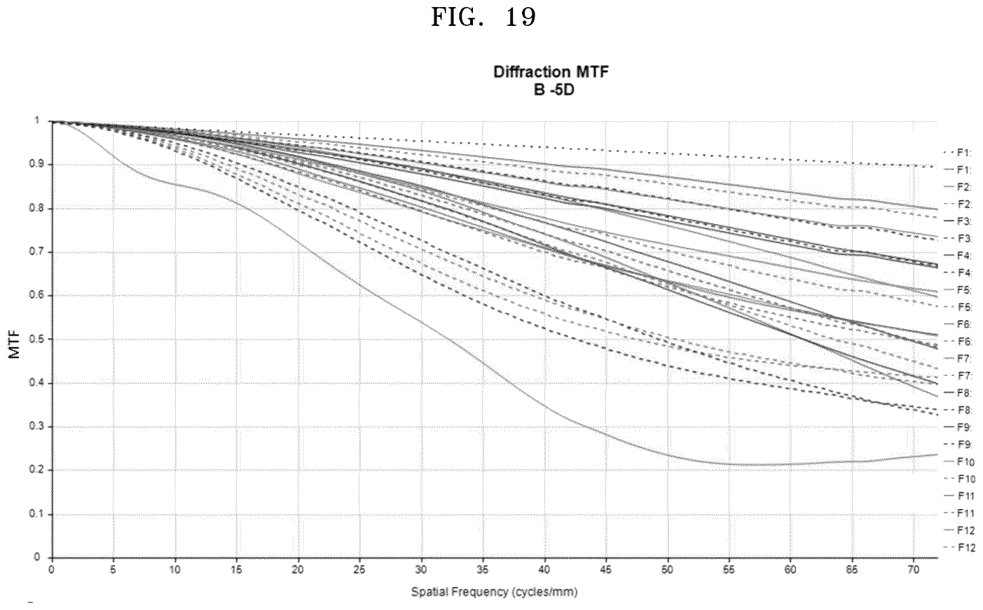

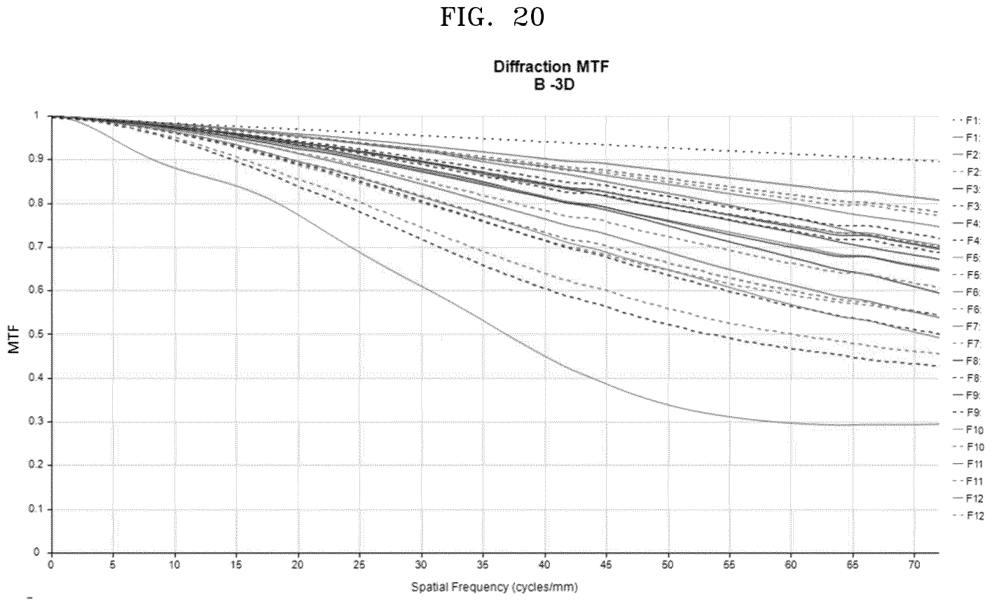

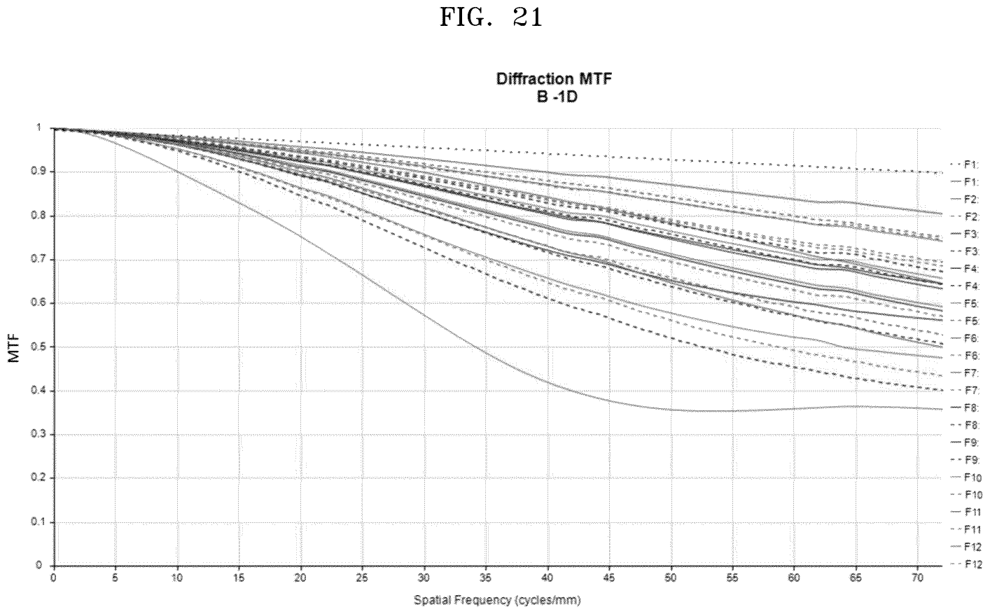

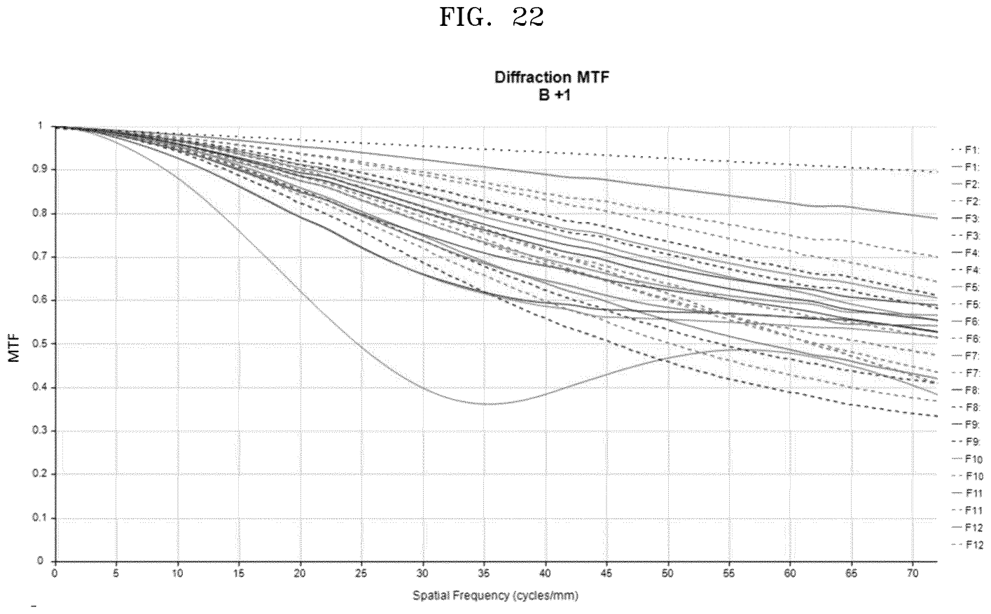

FIG. 18 is an MTF chart of the catadioptric lens system 100 for a blue wavelength (486.0 nm) at −7D, FIG. 19 is an MTF chart of the catadioptric lens system 100 for a blue wavelength at −5D, FIG. 20 is an MTF chart of the catadioptric lens system 100 for a blue wavelength at −3D, FIG. 21 is an MTF chart of the catadioptric lens system 100 for a blue wavelength at −1D, and FIG. 22 is an MTF chart of the catadioptric lens system 100 for a blue wavelength at +1D.

In FIGS. 8 to 22, the horizontal axis represents the spatial frequency, and the vertical axis represents the through-focus MTF at 20 lp/mm. In FIGS. 8 to 22, solid-line curves represent MTFs for lines spreading in a concentric direction from the lens center, and dotted-line curves represent MTFs for lines spreading in a spoke shape from the lens center. In FIGS. 8 to 22, different curves represent MTFs in different fields.

Referring to FIGS. 8 to 22, it may be seen that the catadioptric lens system 100 according to the numerical example described above substantially maintains an MTF value of 0.5 or more of a target resolution of 35 lp/mm at the predetermined wavelength (red wavelength (656.0 nm), green wavelength (587.0 nm), and blue wavelength (486.0 nm)) and the predetermined vision (−7D, −5D, −3D, −1D, and +1D) while the refractive power changes from −7D to +1D.

Moreover, it may be seen that an MTF of 0.5 field at the predetermined wavelength and the predetermined vision is 0.6 or more at fs/4 and the MTF of 0.5 field within the range in which the magnification is adjusted is 70% or more of 0.6.

It may be seen that an MTF of 0.7 field at the predetermined wavelength and the predetermined vision is 0.5 or more at fs/4 and the MTF of 0.7 field within the range in which the magnification is adjusted is 70% or more of 0.5.

It may be seen that an MTF of 0.8 field at the predetermined wavelength and the predetermined vision is 0.4 or more at fs/4 and the MTF of 0.8 field within the range in which the magnification is adjusted is 70% or more of 0.4.

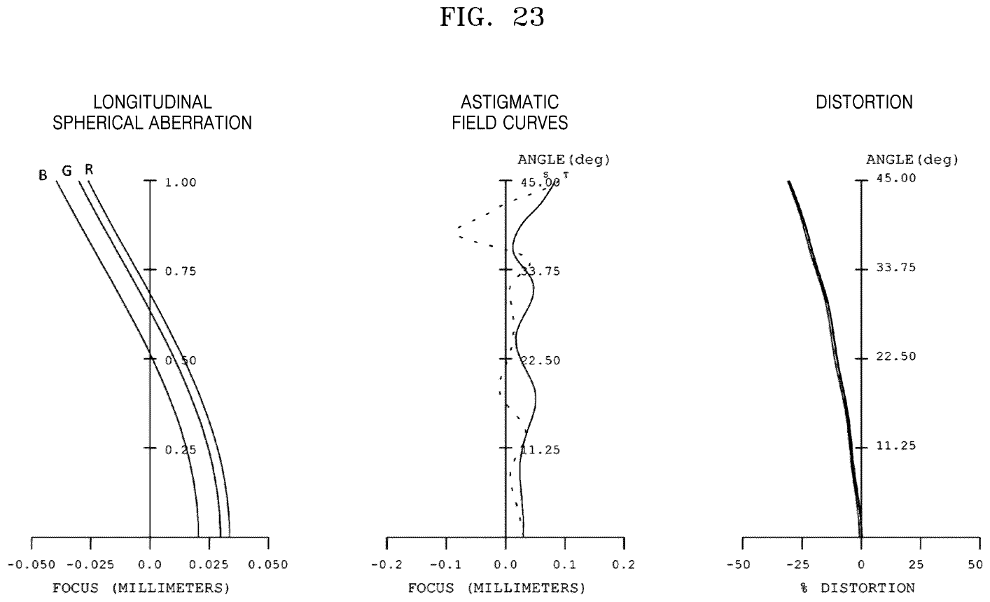

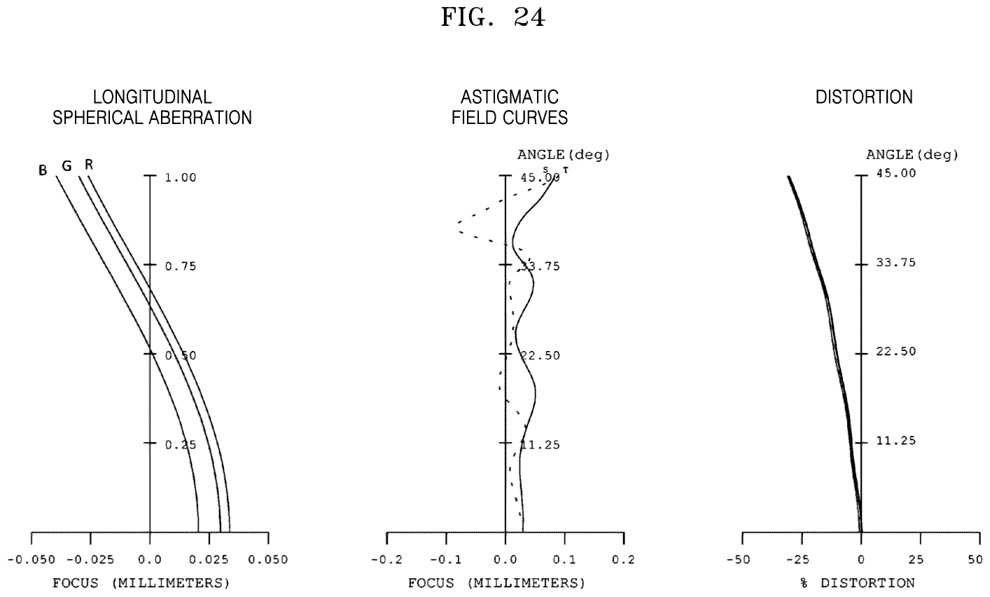

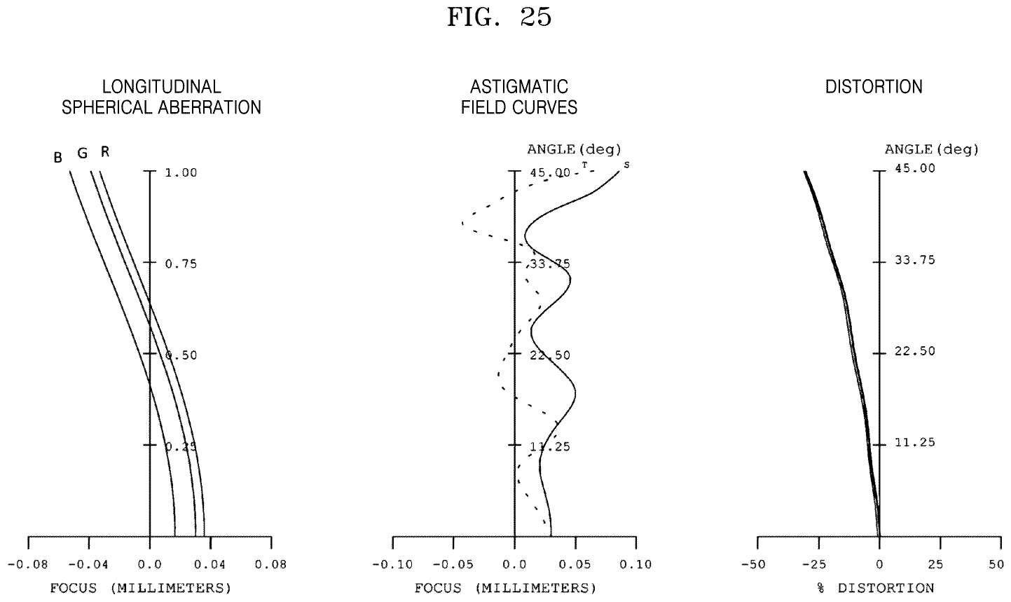

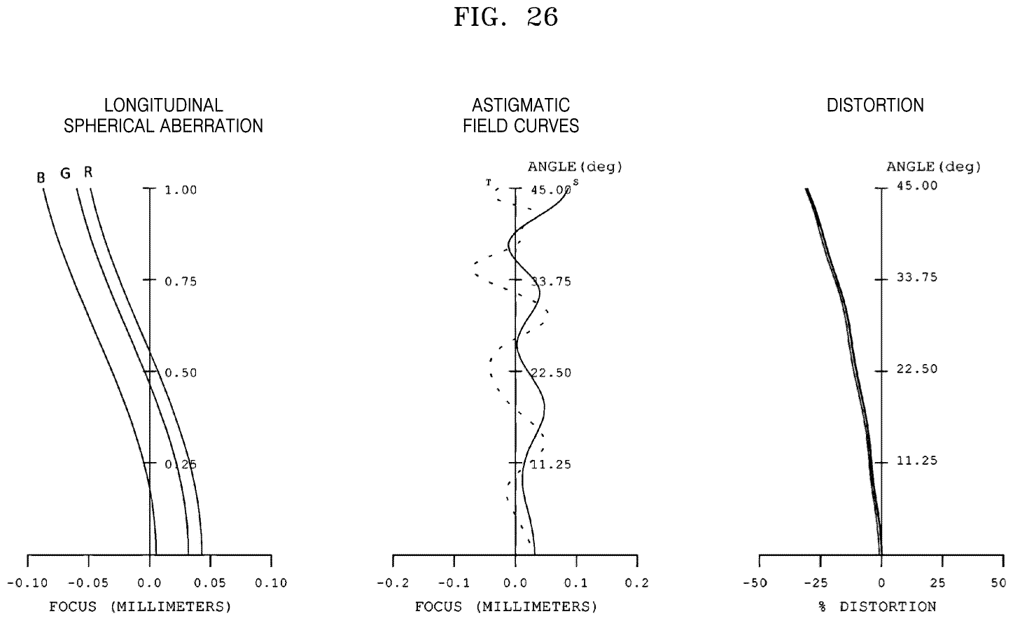

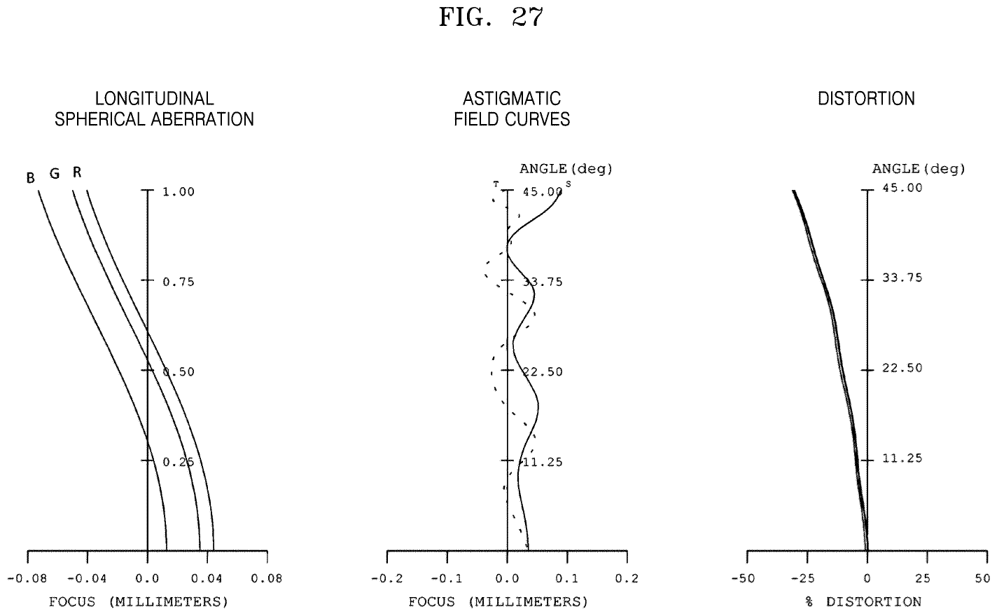

FIG. 23 is an aberration diagram illustrating the longitudinal spherical aberration, astigmatic field curves, and distortion of the catadioptric lens system 100 at a refractive power of −7D, FIG. 24 is an aberration diagram illustrating the longitudinal spherical aberration, astigmatic field curves, and distortion of the catadioptric lens system 100 at a refractive power of −5D, FIG. 25 is an aberration diagram illustrating the longitudinal spherical aberration, astigmatic field curves, and distortion of the catadioptric lens system 100 at a refractive power of −3D, FIG. 26 is an aberration diagram illustrating the longitudinal spherical aberration, astigmatic field curves, and distortion of the catadioptric lens system 100 at a refractive power of −1D, and FIG. 27 is an aberration diagram illustrating the longitudinal spherical aberration, astigmatic field curves, and distortion of the catadioptric lens system 100 at a refractive power of +1D.

The catadioptric lens system and the video see-through apparatus including the same according to the present disclosure have been described above with reference to the embodiments illustrated in the drawings in order to facilitate an understanding thereof.

While embodiments have been described with reference to the figures, it will be understood by those of ordinary skill in the art that various changes in form and details may be made therein without departing from the spirit and scope as defined by the following claims and their equivalents.

What is claimed is:

1. A catadioptric lens system implemented in a video see-through apparatus, the catadioptric lens system comprising:
a first lens;
a second lens;
a third lens; and
a fourth lens,
wherein the first lens, the second lens, the third lens, and the fourth lens are sequentially disposed in a direction of an optical axis from a side of a user's eye toward a side of an image surface,
wherein a second surface of the first lens facing the image surface is configured to reflect at least a portion of light from the second lens and a fourth surface of the second lens facing the image surface is configured to re-reflect at least a portion of light reflected from the first lens,
wherein the first lens has a positive refractive power, the second lens has a positive refractive power, the third lens has a negative refractive power, and the fourth lens has a positive refractive power,
wherein the first lens is configured to move in the direction of the optical axis within a distance range of 0.1 mm to 1.1 mm from the second lens, and
wherein a change of refractive power within a movement range of the first lens is within a range of −7D to +1D.

2. The catadioptric lens system of claim 1, wherein the first lens is further configured to move in the direction of the optical axis within a distance range of 0.15 mm to 1.03 mm from the second lens.

3. The catadioptric lens system of claim 1, wherein a modulation transfer function (MTF) of 0.5 field at a predetermined wavelength and a predetermined vision is greater than or equal to 0.6 at fs/4, and
wherein the MTF of 0.5 field within the movement range of the first lens is greater than or equal to 70% 0.6.

4. The catadioptric lens system of claim 1, wherein a modulation transfer function (MTF) of 0.7 field at a predetermined wavelength and a predetermined vision is greater than or equal to 0.5 at fs/4, and
wherein the MTF of 0.7 field within a range in which a magnification is adjusted is greater than or equal to 70% of 0.5.

5. The catadioptric lens system of claim 1, wherein a modulation transfer function (MTF) of 0.8 field at a predetermined wavelength and a predetermined vision is greater than or equal to 0.4 at fs/4, and
wherein the MTF of 0.8 field within a range in which a magnification is adjusted is greater than or equal to 70% of 0.4.

6. The catadioptric lens system of claim 1, wherein an eye relief of the catadioptric lens system is within a range of 11 mm to 14 mm.

7. The catadioptric lens system of claim 1, wherein a field of view of the catadioptric lens system is within a range of 85° to 95°.

8. The catadioptric lens system of claim 1, further comprising:
a reflection polarizer between the first lens and the second lens;
a quarter-wavelength plate between the reflection polarizer and the second lens; and
a half mirror between the second lens and the third lens.

9. The catadioptric lens system of claim 8, wherein the reflection polarizer and the quarter-wavelength plate are in a film form and on the second surface of the first lens.

10. The catadioptric lens system of claim 8, further comprising a second quarter-wavelength plate between the fourth lens and the image surface.

11. The catadioptric lens system of claim 8, further comprising a linear polarizer and a second quarter-wavelength plate on an image-surface-side of the fourth lens.

12. The catadioptric lens system of claim 1, wherein the first lens, the second lens, the third lens, and the fourth lens comprise a plastic lens.

13. The catadioptric lens system of claim 1, wherein the first lens, the second lens, the third lens, and the fourth lens comprise an aspherical lens.

14. The catadioptric lens system of claim 1, wherein the second surface of the first lens comprises a flat surface.

15. A video see-through apparatus comprising:
a display panel configured to output light of an image; and
a catadioptric lens system comprising:
a first lens;
a second lens;
a third lens; and
a fourth lens,
wherein the first lens, the second lens, the third lens, and the fourth lens are sequentially disposed in a direction of an optical axis from a side of a user's eye toward a side of an image surface,
wherein a second surface of the first lens facing the image surface is configured to reflect at least a portion of light from the second lens and a fourth surface of the second lens facing the image surface is configured to re-reflect at least a portion of light reflected from the first lens,
wherein the first lens has a positive refractive power, the second lens has a positive refractive power, the third lens has a negative refractive power, and the fourth lens has a positive refractive power,
wherein the first lens is configured to move in the direction of the optical axis within a distance range of 0.1 mm to 1.1 mm from the second lens, and
wherein a change of refractive power within a movement range of the first lens is within a range of −7D to +1D.

16. The video see-through apparatus of claim 15, wherein the first lens is further configured to move in the direction of the optical axis within a distance range of 0.15 mm to 1.03 mm from the second lens.

17. The video see-through apparatus of claim 15, wherein a modulation transfer function (MTF) of 0.5 field at a predetermined wavelength and a predetermined vision is greater than or equal to 0.6 at fs/4, and
wherein the MTF of 0.5 field within the movement range of the first lens is greater than or equal to 70% 0.6.

18. The video see-through apparatus of claim 15, wherein an MTF of 0.7 field at a predetermined wavelength and a predetermined vision is greater than or equal to 0.5 at fs/4, and
wherein the MTF of 0.7 field within a range in which a magnification is adjusted is greater than or equal to 70% of 0.5.

19. The video see-through apparatus of claim 15, wherein an MTF of 0.8 field at a predetermined wavelength and a predetermined vision is greater than or equal to 0.4 at fs/4, and
wherein the MTF of 0.8 field within a range in which a magnification is adjusted is greater than or equal to 70% of 0.4.

20. The video see-through apparatus of claim 15, wherein an eye relief of the catadioptric lens system is within a range of 11 mm to 14 mm.
